(19) United States
(12) Patent Application Publication
(10) Pub. No.: US 2016/0358345 A1
(43) Pub. Date: Dec. 8, 2016

(54) METHOD AND SYSTEM FOR SIMULATING AN IMAGE OF A WALL TO BE PAINTED

(71) Applicant: 3M INNOVATIVE PROPERTIES COMPANY, Saint Paul, MN (US)

(72) Inventors: Judy J. MA, Woodbury, MN (US); Leonard M. MARTINEZ, Hugo, MN (US); Nicolas A. ECHEVERRI, Woodbury, MN (US)

(21) Appl. No.: 15/114,088

(22) PCT Filed: Feb. 11, 2015
(86) PCT No.: PCT/US2015/015306

§ 371 Date: Jul. 26, 2016

Related U.S. Application Data
(60) Provisional application No. 61/946,357, filed on Feb. 28, 2014.

(51) Int. Cl. G06T 11/00

(52) U.S. Cl. CPC G06T 11/001

(57) ABSTRACT

A system for providing a simulated image of a wall area to be painted, wherein the wall area to be painted has a perimeter and a plurality of corner locations, wherein the wall area to be painted includes three or more markers having a predetermined shape and size or a predetermined pattern, each marker positioned at a different corner location of the wall area to be painted. A modified reference image can incorporate selections made by a user and a reference image. The modified reference image can depict a possible paint scheme for a wall or room.

### BACKGROUND

Paint allows a user to transform the look and feel of a room. However, painting can be time consuming, labor intensive, and the results can be disappointing or not what the user expected. Additionally, choosing a paint color can involve many trips to and from a paint store, such as to pick up paint swatches, pick up a test sample of paint, pick up paint, and sometimes back to the store to pick up additional paint if a user runs out. The numerous trips to and from a paint store can leave a user frustrated and can increase the amount of time a project takes. Adding to the length of a project, on average consumers spend 4 to 6 weeks to pick out the paint color.

Photo editing software can help a consumer visualize the look of a room with different paint colors, such as to speed up the process of selecting a color and helping visualize the results. However photo editing software is frequently difficult to use and can frustrate the consumer. Further, different lighting conditions can alter the way the paint looks. A consumer might like the paint color in one lighting condition; however the consumer can dislike the paint color in another lighting condition.

Accordingly, there is a need for a system to easily simulate an image of a wall that a user intends to paint.

### SUMMARY

In an example, a system for providing a simulated image of a wall area to be painted is provided. The wall area to be painted has a perimeter and a plurality of corner locations, and includes three or more markers having a predetermined shape and size or a predetermined pattern, each marker positioned at a different corner location of the wall area to be painted is provided. The system can include a reference image receiving module configured to receive a digital reference image of the wall area to be painted including the markers; a processor comprising a perimeter identification module configured to identify corner locations by identifying the predetermined shape and size or the predetermined pattern of each marker on the reference image, identify line locations extending between the markers and combine the line locations extending between the markers to form a perimeter path; a user input module configured to receive a color selection from a user input device; and a simulation module configured to provide a modified reference image of the wall area to be painted simulating the color selection on the wall area to be painted within the perimeter path.

In an example, the markers each define a surface comprising a temporary attachment mechanism.

In an example, each marker has the predetermined shape and size, the system further comprising a pad comprising a stack of the three or more markers, wherein each marker is configured to be peeled off of the pad and then be attached to the perimeter of the wall area to be painted using the temporary attachment mechanism.

In an example, each marker has the predetermined shape and size, the system further comprising a roll comprising a series of the three or more markers, wherein each marker is configured to be peeled off of the roll or torn of the roll, separated from the other markers and then be attached to the perimeter of the wall area to be painted using the temporary attachment mechanism.

In an example, each marker has the predetermined pattern, wherein the pattern is a repeating pattern.

In an example, the system can further include a color option module configured to at least one of the following: (1) present a user with a color collection comprising an image of swatches of a plurality of colors, (2) receive a color identification from a user, and (3) enable the user to select a color from a photograph.

In an example, the color option module matches a color selected by the user to the closest matching color from a library of predetermined color options.

In an example, the system can further include comprising a simulation adjustment module configured to change the color selection on the modified reference image to be an adjusted color selection, wherein the simulation adjustment module is configured to receive the adjusted color selection while displaying the modified reference image.

In an example, the system can further include a pattern simulation module for receiving a pattern selection from the user and providing the modified reference image with a color pattern corresponding to the pattern selection within the perimeter path.

In an example, the user selects two or more colors for the selected pattern.

In an example, the pattern simulation module receives a resizing selection from the user.

In an example, the reference image receiving module is configured to receive a lighting condition of the reference image.

In an example, the system can further include a light adjustment module for receiving a lighting condition selection from the user and providing the modified reference image simulating the color selection in the selected lighting condition within the perimeter path.

In an example, the system can further include an area calculation module configured to calculate an estimated surface area of the wall area to be painted using a known dimension of the predetermined shape or predetermined pattern and configured to provide the estimated surface area to the user.

In an example the system can further include a paint volume estimation module configured to calculate an estimated volume of paint required to paint the area to be painted using the estimated surface area.

In an example the system can further include a project estimation module configured to calculate a project time estimation based at least on the estimated surface area.

In an example a method for providing a simulated image of a wall area to be painted, wherein the wall area to be painted has a perimeter and a plurality of corner locations, wherein the wall area to be painted includes three or more markers having a predetermined shape and size or a predetermined pattern, each marker positioned at a different corner location of the wall area to be painted, the method comprising: receiving a digital reference image of the wall area to be painted including the markers; identifying a perimeter path of the wall area to be painted on the reference image by a processor, comprising the steps of identifying a corner location of each marker by identifying the predetermined shape and size or the predetermined pattern of each marker on the reference image, identifying line locations extending between the markers and combining the line locations extending between the markers to form a perimeter path; receiving a color selection from a user from a user input device; and providing a modified reference image of the wall area to be painted simulating the color selection on the wall area to be painted within the perimeter path is provided.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

The invention may be more completely understood in connection with the following drawings, in which:

FIG. 1 is a depiction of an example electronic device wherein one or more of the examples set forth herein may be implemented.

FIG. 2 is a schematic of different modules in the system, according to an example.

FIG. 3 is a flow chart of steps taken in the system, according to an example.

FIG. 4 is a view of a room, according to an example.

FIG. 5 is a view of a room with markers, according to an example.

FIG. 6 is a view of a room with markers, according to an example.

FIGS. 7A-7E are views of different markers, according to different examples.

FIG. 8A is a portion of a user interface, according to an example.

FIG. 8B is a portion of a user interface, according to an example.

FIG. 9 is a portion of a user interface, according to an example.

FIG. 10 is a portion of a user interface, according to an example.

FIG. 11 is a portion of a user interface, according to an example.

FIG. 12 is a portion of a user interface, according to an example.

FIG. 13 is a portion of a user interface, according to an example.

FIG. 14 is a portion of a user interface, according to an example.

FIG. 15 is a portion of a user interface, according to an example.

FIG. 16 is a portion of a user interface, according to an example.

FIG. 17 is a portion of a user interface, according to an example

FIG. 18 is a wall with markers, according to an example.

FIG. 19 is a roll of markers, according to an example.

FIG. 20 is a stack of multiple markers, according to an example.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

The painting process can be time consuming and labor intensive. At times, the results can be disappointing, such as if the room or wall does not turn out as the user had hoped. Described herein is a system and method to help a user visualize his or her space after completing the painting project. The user can capture an image of their room or wall that they wish to paint. The image can be digitally modified to show possible outcomes or results after painting the room or wall.

### Electronic Device Examples

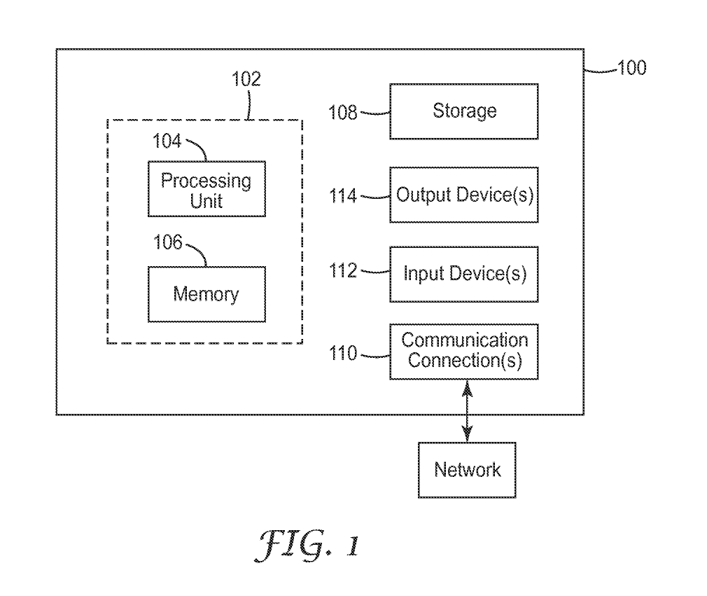

FIG. 1 shows a schematic of an electronic device 100 that can be used in association with the system for providing a simulated image of a wall area to be painted. In an example, the electronic device 100 can include a cellphone, a smart phone, a tablet computer, a Personal Digital Assistant (PDA), media player, or a laptop computer. Certain features of the system are convenient when used on a tablet computer which has a touch screen input interface and a larger display screen than typical cellphones.

In one configuration, the electronic device 100 can include at least one processor 104 and at least one memory component 106. Depending on the exact configuration and type of computing device, the memory component 106 may be volatile (such as RAM, for example), non-volatile (such as ROM, flash memory, etc., for example) or an intermediate or hybrid type of memory component. This combination of the processing unit 104 and the memory unit 106 is illustrated in FIG. 1 by dashed line 102.

In some examples, the electronic device 100 may include additional features, additional functionality or both. In an example, the device 100 can include one or more additional storage components 108, including, but not limited to, a hard disk drive, a solid-state storage device, and/or other removable or non-removable magnetic or optical media. In an example, the storage component 108 can include non-transitory computer readable storage medium. In an example, computer-readable and processor-executable instructions implementing one or more embodiments provided herein can be stored in the storage component 108. The storage component 108 may also store other data objects, such as components of an operating system, executable binaries comprising one or more applications, programming libraries (e.g., application programming interfaces (APIs), media objects, and documentation. The computer-readable instructions may be loaded in the memory component 103 for execution by the processor 104.

The electronic device 100 can include one or more communication connections 110, such as to allow the electronic device 100 to communicate with other devices or a network, such as the Internet. The one or more communication connections 110 can include a modem, a Network Interface Card (NIC), a radiofrequency transmitter/receiver, an infrared port, and a universal serial bus (USB) connection. Such communication connections 110 may comprise a wired connection (connecting to a network through a physical cord, cable, or wire) or a wireless connection (communicating wirelessly with a networking device, such as through visible light, infrared, or one or more radiofrequencies).

The electronic device 100 may include one or more input components 112, such as a touch input device, a keyboard, a mouse, a pen, a voice input device, a digital camera, an infrared camera, or a video input devices, and/or one or more output components 114, such as one or more displays, speakers, and printers. The input components 112 and/or output components 114 may be connected to the electronic device 702 via a wired connection, a wireless connection, or any combination thereof. In an example, the input components 112 or output components 114 can be integral with the electronic device, such that they are contained within a single housing.

The components of the electronic device 100 can be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of the electronic device 100 may be interconnected by a network. For example, the memory component 106 may be comprised of multiple physical memory units located in different physical locations interconnected by a network.

Those skilled in the art will realize that storage devices utilized to store computer readable instructions may be distributed across a network. For example, an electronic device 100 accessible via a network can store computer readable instructions to implement one or more embodiments provided herein. The electronic device 100 may access a computing device and download a part or all of the computer readable instructions for execution. Alternatively, the electronic device 100 may download pieces of the computer readable instructions, as needed, or some instructions may be executed at the electronic device 100 and some at a computing device.

In an example, the electronic device 100 can be configured to perform as the system described herein. The system can provide a simulated image of a wall area that a user intends to paint. The user can capture a reference image of the wall, such as with an input component, such as a camera or an infrared camera. The reference image can be displayed to the user on an output component, such as a display screen. In an example the display screen can include a touch screen, such that the user can interact with the electronic device using the touch screen, including provide input to the electronic device and view information on the touch screen.

Prior to capturing the reference image with a camera, the user can place a marker in each corner of the wall area to be painted. The terms “corner” or “corner locations” refers to points along the perimeter where any two sides of the perimeter meet each other. The electronic device 100 can recognize the markers on the reference image and identify the perimeter of the wall area to be painted based on the locations and number of markers identified by the electronic device 100.

The user can manipulate the reference image, such as to see a simulated image of the wall. The simulated image of the wall can as it would appear with a different color painted on the wall compared to the reference image. The simulated image of the wall can include a pattern. The simulated image can be shown in different lighting configurations, such as natural light, fluorescent light, incandescent light, or halogen light.

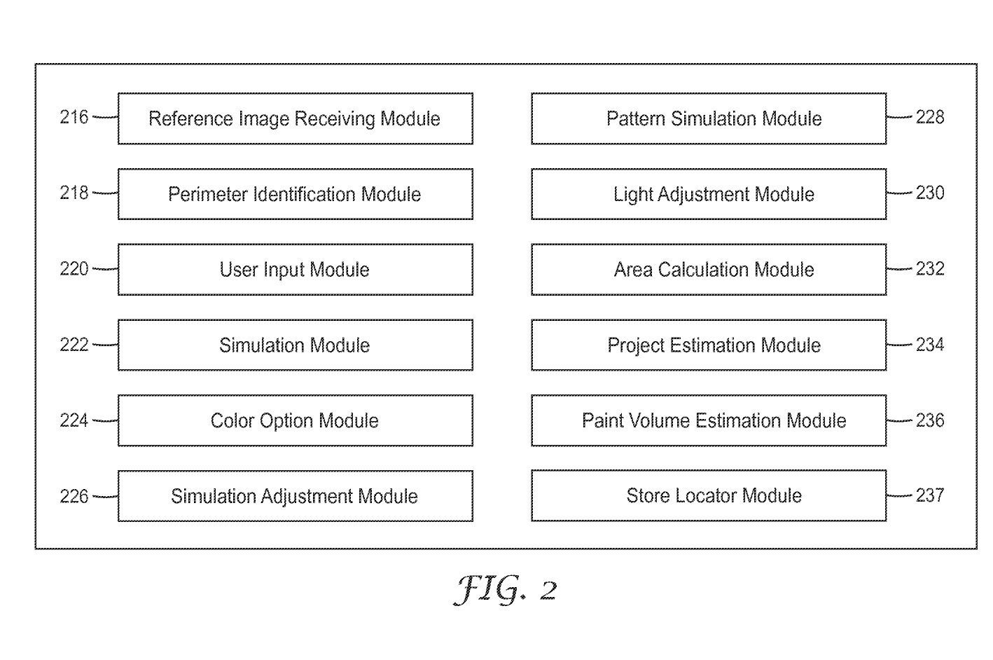

FIG. 2 shows a schematic of the different modules that can be included in the system. The electronic device 100 can include one or more modules that can be configured to carry out different portions of the system. In an example, the system can include one or more of the modules.

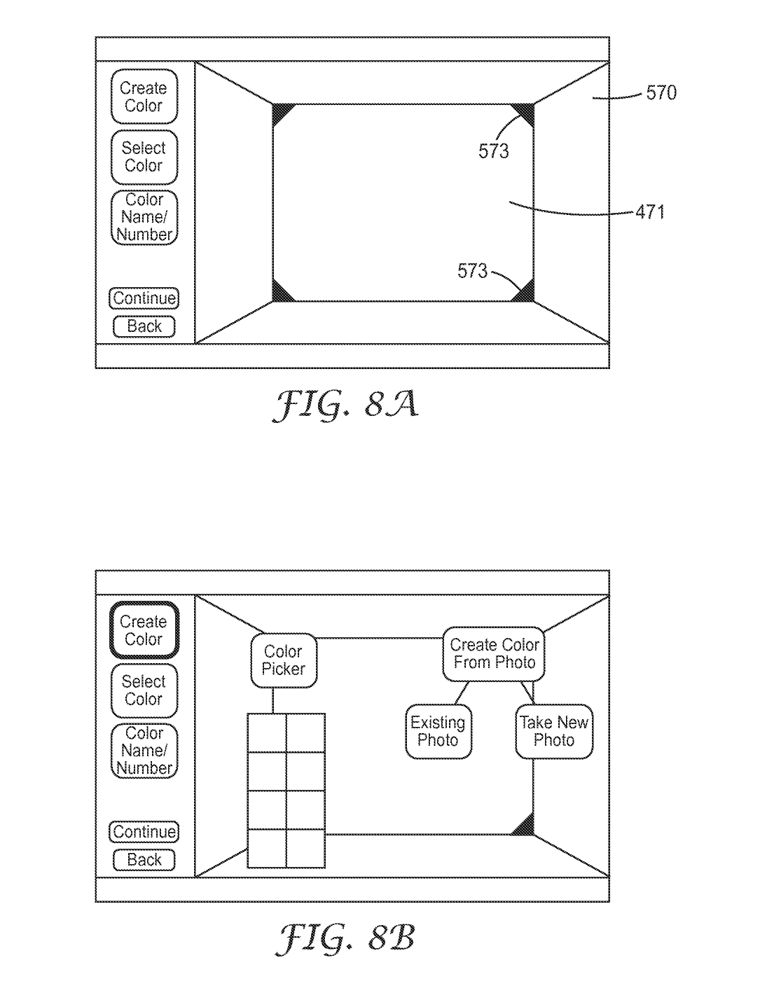

The system can include a reference image receiving module 216. The reference image receiving module 216 can receive a reference image. In an example, the system can prompt a user to capture an image, such as with a camera. The image can then be received by the reference image receiving module 216. In an alternative example, the system can prompt a user to upload an image, such as an image that is stored on the electronic device 100. The user can select an image and upload the image as the reference image. The image can be digital. One example of a user interface associated with the reference image receiving module 216 can be seen in FIG. 8.

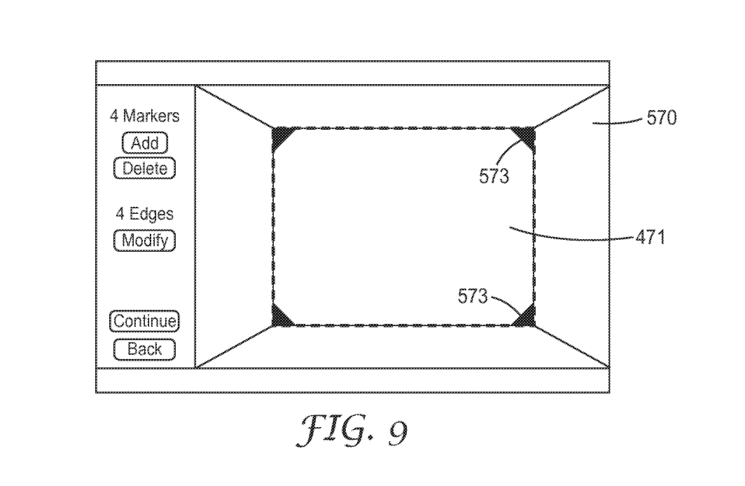

The system can include a perimeter identification module 218. The perimeter identification module 218 can be configured to identify the corner locations of the wall to be painted, such as by markers placed by a user. The perimeter identification module 218 can identify markers, such as when the markers have a known size, shape, design, or image. The perimeter identification module 218 can be configured to identify the perimeter of the wall area to be painted, such as by connecting the markers to each other to define an area within the image. The perimeter identification module 218 can connect a first marker with a second marker with a line, such as to define the edge of the wall area in the digital image. The lines between markers can be connected to form a perimeter path. The perimeter path can define the outside edge of a wall are to be painted. The user interface associated with the perimeter identification module 218 can be seen in FIG. 9

The system can include a user input module 220. The user input module can be configured to receive input from the user, such as a color selection, a pattern selection, or a lighting selection. The user input module 220 can be configured to process the input from the one or more input devices 112.

The system can include a simulation module 222. The simulation module 222 can be configured to show a modified reference image of the wall area to be painted. The modified reference image 222 can include the lines connecting the markers to show the edge of the wall. The modified reference image can include a different color within the perimeter path in comparison to the reference image, in order to simulate what the wall to be painted would look like if painted with the different color. The modified reference image can also show the different color as it would appear in a variety of different lighting conditions, such as natural light, fluorescent light, incandescent light, or halogen light. In addition to showing the wall to be painted with a single, solid color, the system can also create a modified reference image of the wall to be painted with a simulated painted pattern, as will be discussed further herein.

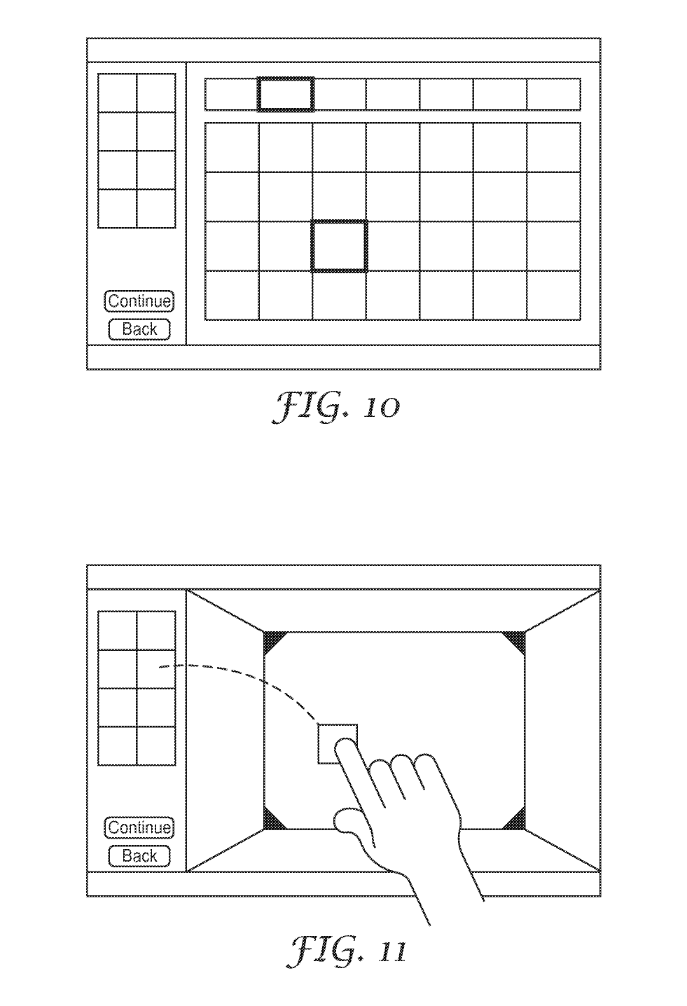

The system can include a color option module 224. The color option module 224 can be configured to present a user with a color collection. The color option module 224 can be configured to allow the user to select a color that the user wishes to see digitally applied to the wall or room to be painted, such that the user can visually review the outcome of the selected color option. In an example, the color collection can include an image of swatches of a plurality of different colors, such as red, orange, yellow, green, blue, purple, black, white, and brown, and many shades thereof. The color option module 224 can be configured to receive a color identification from a user. A user can identify a color such as with an RGB value based on the RGB color model. Alternatively, a user can identify a color using a hexidecimal number, or hex triplet, that is used in computing applications to represent colors. The color option module 224 can be configured to enable the user to select a color from a photograph, such as the reference image or an alternative image the user selects. The user can select a color from a color picker. The user can select a base color, such as blue. The user can be presented with various shades of the blue selected, such as ranging from dark to light. In an example, the color option module 224 can match a color selected by the user to the closest matching color from a library of predetermined color options, such as by comparing RGB or hex values. The library of predetermined color options can be color options for different paints sold commercially by different paint suppliers. The user interface associated with the color option module 224 can be seen in FIG. 10 and FIG. 11.

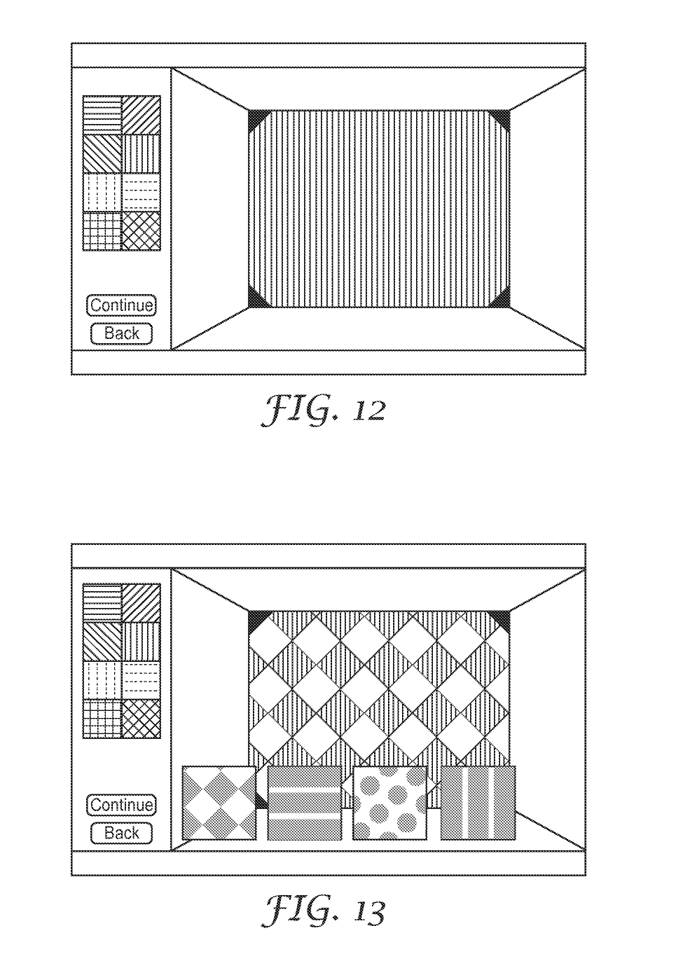

The system can include a simulation adjustment module 226. The simulation adjustment module 226 can be configured to allow the user to modify the reference image, such as to obtain the modified reference image. The simulation adjustment module 226 can be configured to change the color on the modified reference image to be an adjusted color selection. The adjusted color selection can be a color selected by the user. The simulation adjustment module 226 can display the modified reference image at the same time that color options are displayed. The modified reference image can include the reference image with the wall or room to be painted the color that was previously selected by the user. The user interface associated with the simulation adjustment module 226 can be seen in FIG. 12.

The system can include a pattern simulation module 228. The pattern simulation module 228 can be configured to receive a pattern selection from the user and display the modified reference image including the pattern selected on the wall that is to be painted. In an example, a pattern selected by a user can include one, two or more colors. A pattern with one color can be displayed over the wall color of the reference image so that the existing wall color is a part of the pattern shown in the modified reference image. In another example, the user choses a new color to be applied to the wall and then choses a pattern and color to be further superimposed on the new color. In an example, a pattern can be scaled, such as to make it larger or smaller in relationship to the wall to be painted. In an example, a pattern can be rotated, such as to achieve an alternative look from the pattern. In an example, a user can be provided with a web link that displays techniques for choosing and applying patterns, including dots, stripes and other patterns. The user interface associated with the pattern simulation module 228 can be seen in FIG. 13.

The system can include a light adjustment module 230. The light adjustment module can receive a lighting condition selection from the user and provide the modified reference image simulating the color selection in the selected lighting condition. In an example, the user can selected between natural light settings, such as morning light, afternoon light, and evening light. In an example, the user can select between non-natural light settings, such as halogen, incandescent, and compact fluorescent light (CFL). The user interface associated with the light adjustment module 230 can be seen in FIG. 14. In one example, the user is prompted to enter a light setting under which the reference image was taken, which can be referred to as a reference light setting. The system modifies the reference image based on knowing the reference light setting to arrive an adjusted light setting in a modified reference image. For example, those of skill in the art are aware of how to modify colors in a digital image to simulate the appearance of a different light condition.

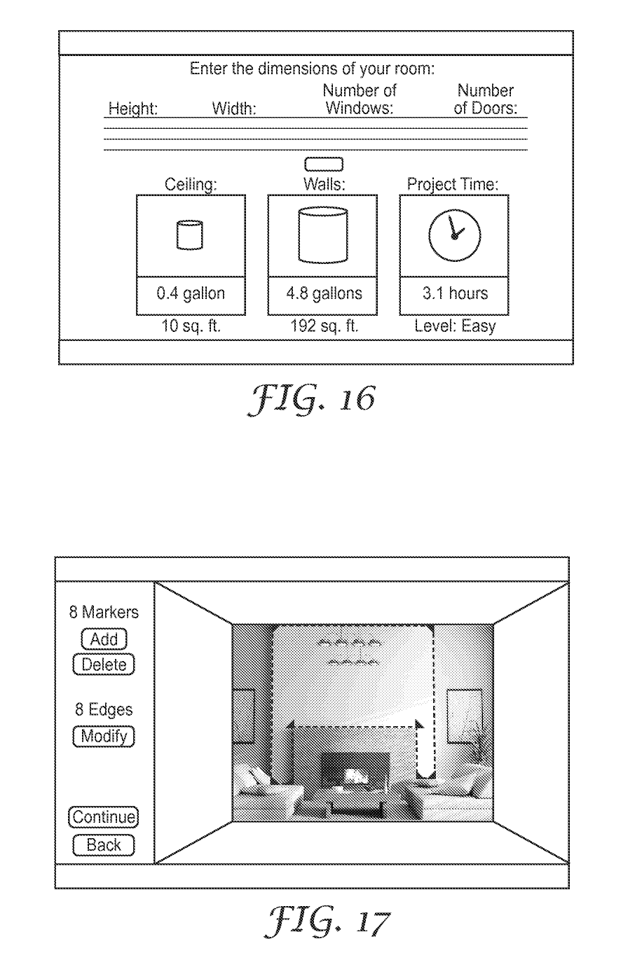

The system can include an area calculation module 232. The area calculation module can calculate an estimate of the surface area of the wall to be painted, such as by using a known dimension of a marker. The area calculation module 232 can provide the user with the estimated surface area of the wall to be painted. The user interface associated with the area calculation module 232 can be seen in FIG. 16.

The system can include a project estimation module 234. The project estimation module 234 can estimate the amount of time a project will take a user to complete. In an example, the estimated time can be based on the estimated surface area of the wall to be painted. In one example, the estimated time is based on the complexity of the surface to be painted, including the presence and number of windows and doors that need to be painted around. In an example the estimated project time can include time for preparation for painting, painting, and time for cleaning up after painting. Time for preparation for painting can include steps that can take place before a user paints the wall, such as taping around the perimeter, such as baseboards or door frames. Time for taping can be based on the length of the perimeter path. The user interface associated with the project estimation module 234 can be seen in FIG. 16. The user is asked to input the dimensions of a room to be painted, such as the height and width, a number of windows and a number of doors. In one example, the system has estimated a length and a height of a wall to be painted using the area calculation module 232, and so the user only need to enter the width of the room. In one example, the user is prompted to enter all dimensions of the room to be painted.

The project estimation module 234 can also estimate a level of difficulty of the project and can display the estimated level of difficulty to the user, as shown in FIG. 16. In the example, of FIG. 16, the level of difficulty is displayed as “Easy”. Other possible level of difficulty options that can be displayed include medium, moderately difficult, difficult or expert. In an example, the level of difficulty can be based on the estimated surface area of the wall to be painted. In an example, the level of difficulty is based on if a pattern is included. In an example, more complex patterns can be given a more difficult rating. In one example, the level of difficulty is based on the complexity of the surface to be painted, including the presence and number of windows and doors that need to be painted around. In an example the level of difficulty can be based on the complexity of preparation for painting, painting, and cleaning up after painting.

The system can include a paint volume estimation module 236. The paint volume estimation module 236 can be configured to estimate the volume of paint required to paint the area. The estimation of the volume of paint can be at least partially based on the estimation of the surface area. The user interface associated with the paint volume estimation module 236 can be seen in FIG. 16.

The system can include a store locator module 237. The store locator module 237 can be configured to determine the closest store to a user's location that has the supplies the user needs based on the selections made. The store locator can choose a store based on proximity to user. The store locator can choose a store based on the supplies the store has and the supplies need based on the selections.

In an example, the processor can include one or more of the modules listed above. The processor can be configured to execute the modules as described.

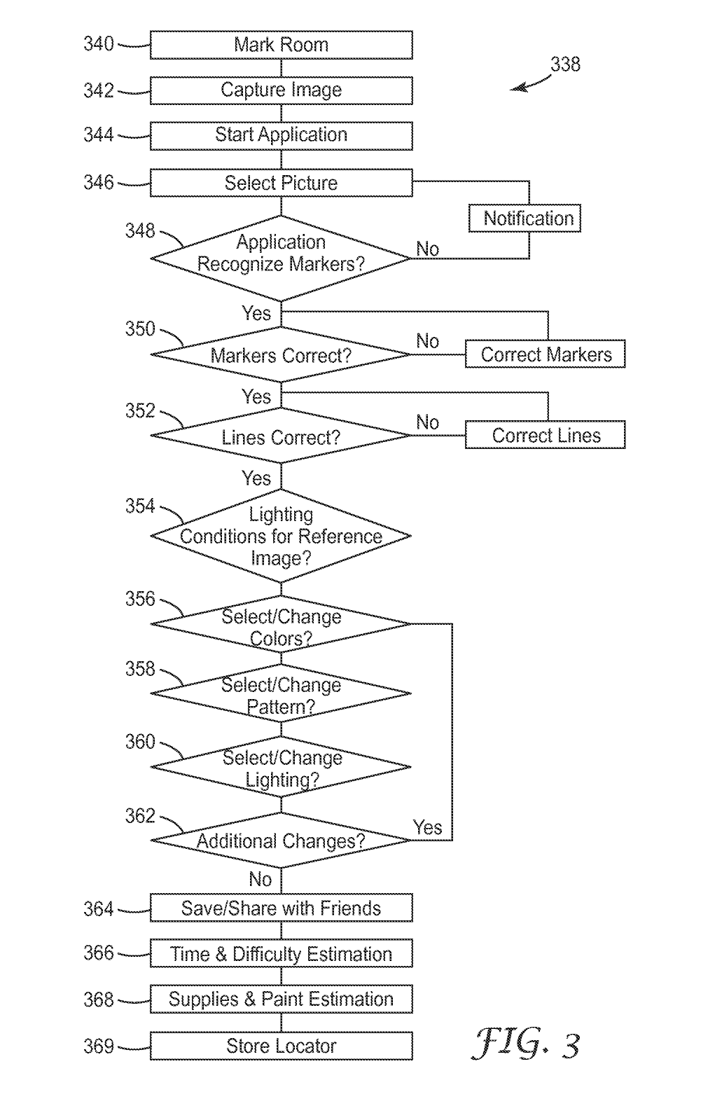

FIG. 3 shows a flow chart of steps taken in the system 338, according to an example. The system 338 can include an application on an electronic device. The application can be downloaded to the electronic device, such as from the Internet.

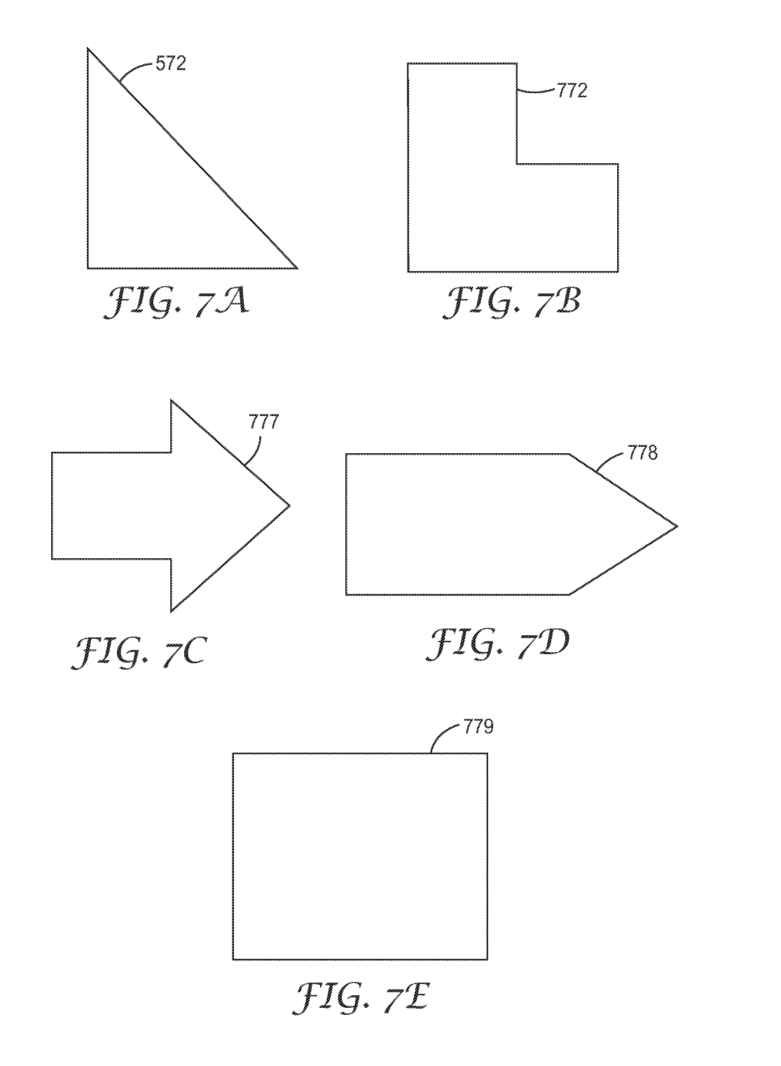

A user can mark the corners of a wall or room that the user wishes to paint at step 340. The user can mark the corners of the wall with markers, such as the examples of markers described in reference to FIG. 7A-7E. The corners of the exterior perimeter of the wall may be marked, as well as the corners of any inner perimeters of the area to be painted, such as around doors, windows and other features. After marking the corners, the user can capture an image of the wall at step 342, such as with a digital camera.

After capturing an image of the wall at step 342, the user can start the application at step 344. In an alternative example, the user can start the application prior to capturing an image of the wall, and the application can prompt the user to capture an image of a wall.

The user can select the image to the application at step 346. The image can be designated as the reference image, such as the image of the original wall with markers disposed in the corners. Once the image is selected or upload to the application, the application can determine if there are any images of markers in the image at step 348. The detection of the images of markers is based on a predetermined shape or a predetermined pattern that the system is looking for in the reference image. If there are not any images of markers detected in the image, the user can be notified that the application did not recognize any markers in the image. The notification can include a dialogue window, such as a window that opens and informs the user to apply markers to the room or select a different image. The application can prompt the user to select a different image or capture another image with markers. In an example, the application will not proceed until the application recognizes at least one marker in the selected reference image.

In an example, after the application recognizes that there are markers in the reference image, the user can be asked to confirm if the correct number of markers is recognized by the application at step 350. If an incorrect number of markers are recognized by the application, the user can manually add additional markers to the reference image or delete excess markers from the reference image.

Once the correct number of markers is achieved on the reference image, the application can connect the markers with lines at step 352, such as lines that represent the edges of the wall to be painted. The user can then be asked to confirm that the lines are located in the approximate locations of the edges of the wall. If the lines are located incorrectly, such as if the markers are connected in an incorrect order, the user can adjust the lines to be positioned correctly.

The user can be asked to enter the lighting conditions of the reference image at step 354. In an example, the user can enter the lighting condition of the reference image after the lines connecting the markers have been confirmed. In an alternative example, the user can enter the lighting conditions of the reference image after the image is uploaded to the application, or after the image is captured.

The user can select or change a color at step 356 that they wish to view on the wall. After the user has selected a color, a modified reference image can be shown to the user. The modified reference image can include the reference image with the wall changed to the color that the user selected. The user can repeat the color selection step 356 until the user has reached a decision on the color the user likes the most, such as the color the user possibly intends to paint the wall.

The user can select or change a pattern at step 358 for the wall. A pattern can include one new color with a portion of the pattern remaining the same color as the wall is in the reference image. In an example, the pattern can include two or more new colors, such as colors that are not on the wall in the reference image. The application can update the modified reference image to include the pattern that the user selected on the wall.

The user can select or change a lighting condition at step 360. In an example, the user can selected a lighting setting, such as morning sunlight, afternoon sunlight, halogen light, or CFL light. The modified reference image can show the wall with the selected lighting condition.

The user can be asked if they want to change any of the selections they have previously made at step 362, such as the color selection, the pattern selection, or the lighting condition. If the user wishes to change a selection the modified reference image can be updated to reflect the newly selected choice.

The user can save the modified reference image at step 364 and the information that corresponds to the modified image. The user can share the image with friends, such as through social media at step 364. The modified reference image can be stored or saved, such that a user can open or review the modified reference image and the data that is incorporated into the modified reference image (e.g., color choice, pattern choice, lighting conditions).

The application can estimate the time and difficulty of the project at step 366. After the user has finalized the selection process, the application can estimate the time it will take a user to paint the wall to reflect the choices the user made. The application can incorporate surface area to be painted, perimeter length to be painted, and if a pattern is going to be painted on the wall. The application can also rate the difficulty of the project that the user has selected. In an example, the application can rate the difficulty on a numerical scale such as 1 to 10. In an example, the application can rate the difficulty as easy, moderate, or difficult.

The application can estimate the tools and paint needed for the project at step 368. In an example, the application can estimate or recommend the supplies a user might need for the selected project. The supplies can include amount of paint, the type of paint, amount of masking tape, stencils, or paint brushes.

The application can recommend a store to the user at step 369. In an example, the application can recommend the closest store that has the supplies the user needs. In an example, the application can recommend the closest store to the user. If the closest store does not have all of the supplies the user needs, the application can recommend the most similar supplies that the store has, or recommend a different store that has all of the supplies the user needs or the supplies that the closest store does not have.

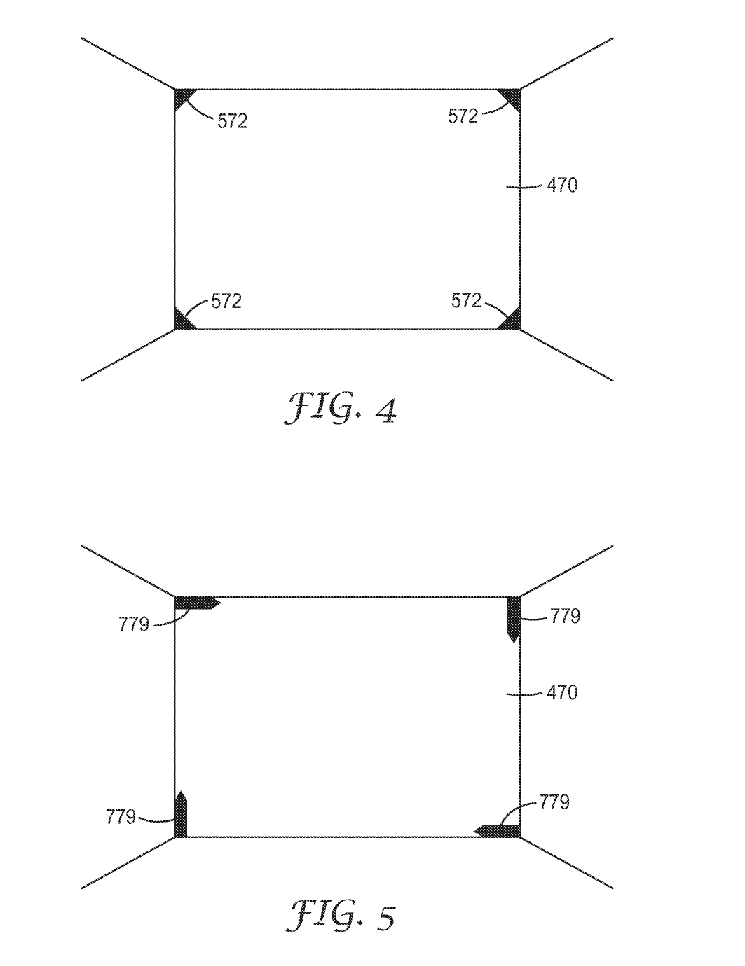

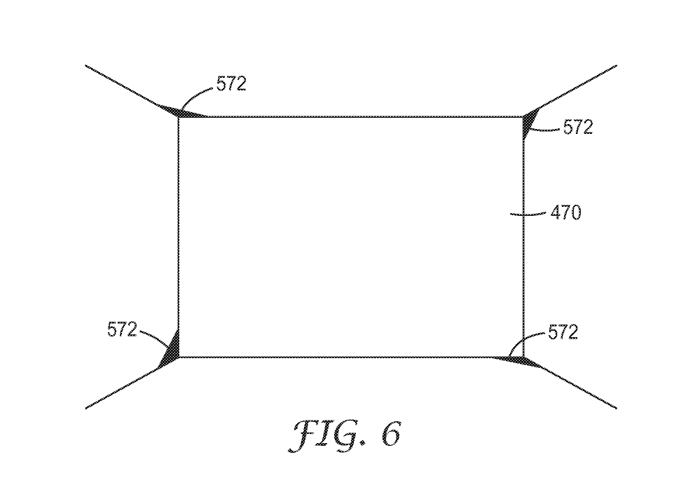

In reference now to FIG. 4, a room with a wall 470 is shown. In an example, a user can desire to paint wall 470. The user can place a marker 572 in each of the corner locations of the wall 470, such as shown in FIG. 4. The user can place a marker 572 at a corner of a piece of furniture, such that the reference image can include the furniture and the user can view the furniture in the modified image of the room. Each marker 572 is shaped as a right triangle, and is positioned so that the right angle corner of the triangle is positioned at the right angle formed by the two sides of the area to be painted that come together at that corner. FIG. 5 shows the wall 470 but with an alternative configuration for the markers, specifically with markers 779 that are shaped as arrows. Markers 779 are positioned so that the arrows point in the direction of the path of a line that forms a perimeter of the area to be painted. The markers, such as markers 572 can alternatively be placed at the corners on an adjacent surface, rather than the wall to be painted, such as another wall, the floor, or the ceiling, as shown in FIG. 6. In an example, the wall that is desired to be painted can include the floor or the ceiling.

The corner locations can refer to the corners of the perimeter of the area to be painted, where lines of the perimeter meet each other. The corner locations do not necessarily contain all or the same corners of the physical wall. FIGS. 4 and 5 show the markers 572 and 779 placed in the corners on the wall to be painted. FIG. 6 shows the markers 572 placed on walls adjacent to the wall to be painted.

FIGS. 7A-7E show markers having different shapes, according to different examples. The marker 572 in FIG. 7A is a right triangle. The marker 772 in FIG. 7B is a right angle or square L-shape. The marker 777 in FIG. 7C is an arrow. The marker 778 in FIG. 7D is an arrow. The marker 779 in FIG. 7E is a square.

In an example, the marker can have one axis of symmetry and be asymmetrical along an orthogonal axis, such as the markers shown in FIGS. 7A to 7D. The asymmetrical aspect of the marker can help to indicate the outside and inside portions of the perimeter. In another example, the marker points in a direction, like the arrows of FIGS. 7C and 7D. The arrow can point in the direction of the next marker, such that a line between the two markers represents an edge of the wall to be painted. The markers can repeatedly point to the next marker, such as to form a closed loop, such as to define the perimeter path of the wall to be painted.

A marker 572 can include a temporary attachment mechanism on a surface, such that the marker 572 can be temporarily attached to a wall and then removed by a user without the use of additional tools. In an example, the temporary attachment mechanism can include an adhesive.

The markers 572 can have a predetermined shape or size, such that the application can recognize the markers 572. Further, the system can create a scale, such as to estimate the surface area of a wall based on a known dimension of a marker 572. In an example, the marker 572 can include a predetermined pattern, such as to differentiate the marker 572, such as to make the marker 572 recognizable to the application. In an example, the pattern can be visible only to an inferred camera, such that the application can confirm the marker 572 is a correct marker to use in association with the application.

The system can include markers 572 in a stack, such as three or more markers on top of each other prior to being placed on a wall. The system can include markers 572 in a roll prior to being separated and placed on a wall. A marker 572 can be peeled or torn off of the stack or roll and placed into the desired location, such as by a user. A roll of markers 572 can include a perforation between each marker 572, such that the markers 572 can be easily separated from each other.

In reference now to FIGS. 8-16, different user interfaces are shown in reference to different steps of the system. FIG. 8A shows a user interface for importing or selecting the reference image 570. The reference image can include images 573 of the markers 572 disposed in the corner locations of the image 471 of the wall to be painted. In an example, more than one wall to be painted can be included in the reference image. FIG. 8B shows a user interface for creating a color, such as if the user selects the “create color” button shown in FIG. 8A. The user can be presented with options for choosing a color, such as from a color picker, or choosing a color from a photograph or image. The color picker can allow a user to select a color. The color picker can present the color selected by the user with additional shades of the color, such as ranging from dark to light. The user can select a color from a photograph. The photograph can be stored on the electronic device or the photograph can be external from the electronic device. The photograph can be an existing photograph or the user can capture a new photograph, such as with a digital camera.

FIG. 9 shows a portion of the user interface where a user is prompted to confirm that all of the markers are correct and the lines connecting the markers are correct. The lines connecting the markers can represent the edge of the wall to be painted. The lines connecting the markers can form a closed loop. The lines can connect the markers in the shortest perimeter path possible. The markers can be connected to the closest markers. In an example, the application will not proceed to the confirmation step of the system unless at least one marker is detected. The user can add or subtract markers as needed. The user can change connecting lines from marker to marker as needed. In an example, the system can automatically add an additional marker if three markers are found in the reference image, such as to complete a path perimeter. In an example, the system can automatically add one or two markers, such as if only two markers are found in the reference image.

FIG. 10 shows a portion of a user interface where the user can choose a color selection. The user can be presented with a color collection comprising an image of swatches of a plurality of colors, such as default colors. The user can identify or upload a color, such as from a picture or image, or with the RGB or hex values. A color selected by a user can be modified, such as by adjusting the brightness saturation or the color hue saturation. A color selected by a user can be previewed, prior to adding the color to the modified reference image. The color selection module can find a paint color that most closely corresponds with a color chosen by the user. The paint color that most closely corresponds can be from a library of predetermined color options, such as color of paint that is commonly available or currently produced by a manufacturer.

FIG. 11 shows a portion of the user interface where the user can choose a color selection to be applied to the wall area to be painted. The color selections made by the user, such as referred to in FIG. 10, can be incorporated into a color options portion of the user interface. A user can “drag and drop” a desired color into the wall area to be painted, such as when the electronic device 100 includes a touch screen.

FIG. 12 shows the user interface with the modified reference image. The modified reference image can be displayed to the user, such that the user can evaluate their decisions based on what the room or wall would look like if the user was to implement the decisions into the room. The modified reference image can be similar to the reference image with selections made by the user incorporated into the image, such as color, pattern or lighting conditions.

FIG. 13 shows the pattern selection portion of the user interface, according to an example. A pattern can be added to the wall, such as a design that incorporates two or more colors. A pattern can include squares, diamonds, horizontal lines, vertical lines, or circles. Additional patterns are also possible. In an example, the patterns can incorporate two or more new colors. In an example the pattern can incorporate the existing color of the wall, such that the user only needs to apply one color to achieve the desired pattern.

The pattern can be displayed in the modified reference image, such as shown in FIG. 13. The pattern selected can be scaled or resized, such as to increase or decrease the size of the pattern relative to the wall. In an example, if the pattern is decreased in size additional shapes or lines can be added to the wall to cover the entire wall, such as if smaller shapes or lines are desired. In an example, the pattern can be rotated, such as to achieve diagonal lines.

The user interface can allow a user to see what the wall would look like under different lighting conditions, such as shown in FIG. 14. The user can select a lighting condition to be shown in the modified reference image. In an example, multiple lighting conditions can be shown side by side, such that the user can compare the wall under different lighting conditions.

In an example, the user can selected between natural light settings, such as morning light, afternoon light, and evening light. In an example, the user can select between non-natural light settings, such as halogen, incandescent, and CFL. It should be understood that additional lighting conditions are also possible. For reference, the user can input the lighting conditions of the reference image, prior to selecting lighting conditions for the modified reference image.

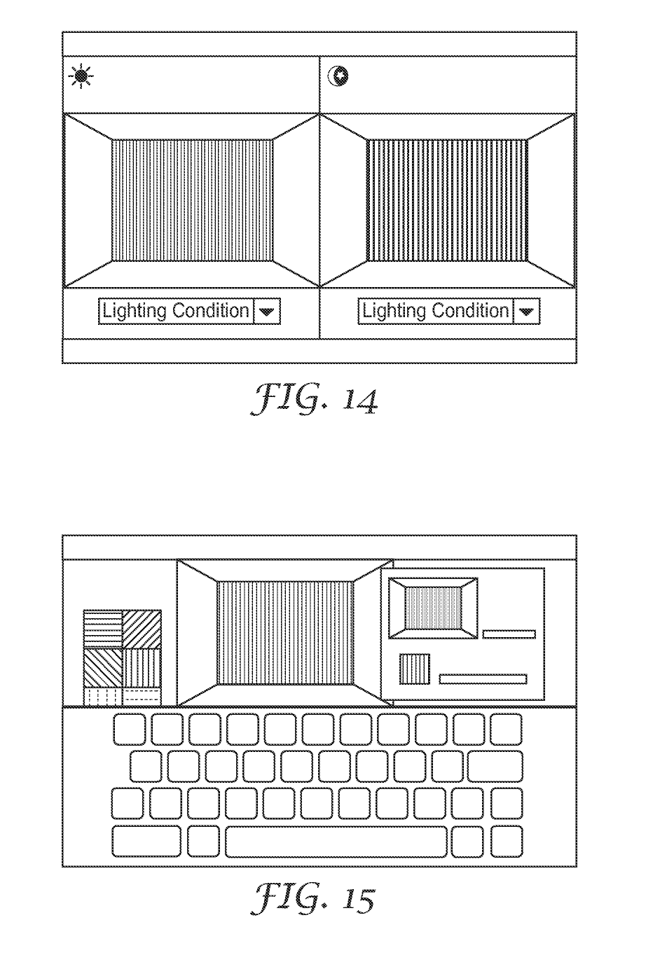

The selections made by the user can be incorporated in the modified reference image. The modified reference image and the associated selections can be saved, such as shown in FIG. 15. The modified reference image can also be shared with friends or family, such as through social media. People can comment on the modified reference image, such as to give advice of which wall he or she prefers when comparing two or more modified reference images.

The system can calculate an estimated time it could take the user to complete the project, such as shown in FIG. 16. The time estimation can be based at least partially on the amount of surface area to be painted, the amount of perimeter in comparison to surface area, or if a pattern is included. The surface area can be estimated, such as by scaling the reference image using a known dimension of a marker. The system can calculate a difficulty estimation, such as easy, moderate, or difficult. They difficulty estimation can be based at least partially on the amount of surface area to be painted, the amount of perimeter in comparison to surface area, or if a pattern is included. The system can calculate a paint estimation, such as the amount of paint a user will need to paint the wall. The system can also create supplies list, such as supplies the user might need to complete the project. The supplies list can include type of paint, amount of paint, brushes, amount of tape, and stencils.

FIG. 17 shows a portion of a user interface, similar to FIG. 9 with a different wall to be painted. As shown in FIG. 17, the wall to be painted can be a shape other than a rectangle. The markers 572 can be placed on the wall to be painted, such as with the right angle at the exterior edge of the wall, such that the system can more easily recognize the shape of the wall to be painted.

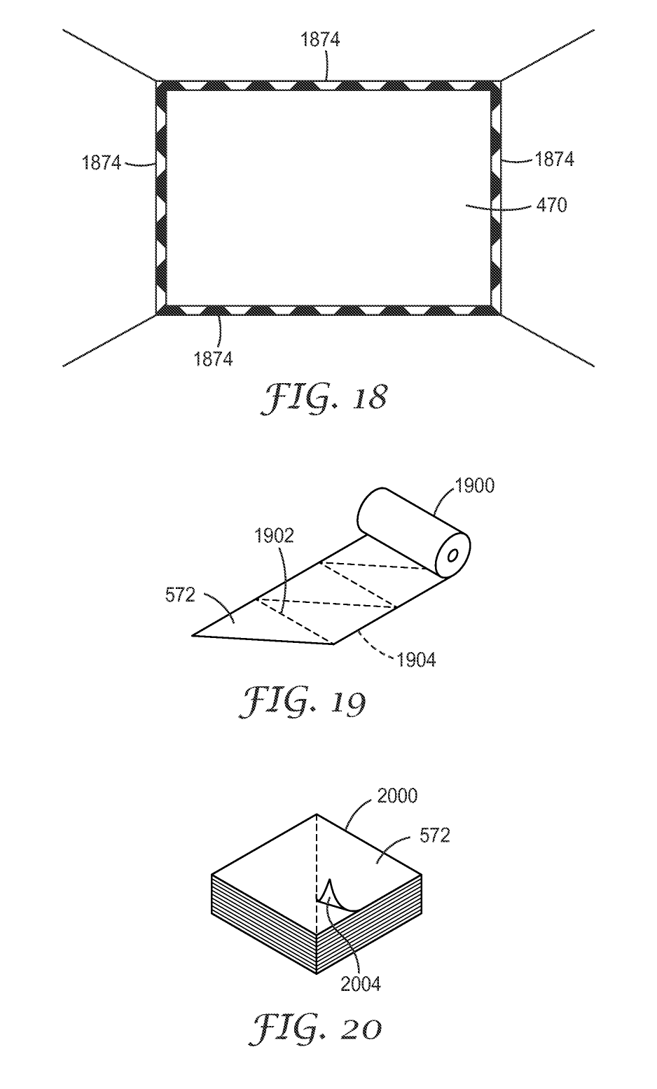

FIG. 18 shows a room, similar to the room in FIG. 4. In an example, the edges of the wall or surface to be painted can be marked with a strip 1874. The user can place the strip 1874 along the edges of the wall or surface. The strip 1874 can include the same properties of the marker 572 described above. The strip 1874 can include a pattern. In an example, the pattern can be visible to the naked eye. In an example, the pattern is visible to a digital camera that detects wavelengths outside of the visible light range, such as in the infrared wavelength range. Such a pattern would be detectable in an image created by such a digital camera, but not visible to the naked eye. In an example, the pattern can be a repeating pattern. The pattern can include a known dimension, such that the system can calculate an estimated length of each edge of the wall or surface. In an example, the calculation can be based at least partially on how many times the known dimension in the pattern is repeated between two points. In one example, the pattern is a series of trapezoid shapes. For example, if seven trapezoid patterns are seen on the strip between two edges, the total width can be 39 inches. In this example, the trapezoid patterns are each 3″ long at a midpoint. Therefore 3″×7 trapezoids=21″ for the pattern area. 3″×6 spaces between trapezoids=18″. The sum is determined by 21″+18″=39″.

FIG. 19 is a roll 1900 of markers 572, according to an example. The markers 572 have perforated edges 1902 so that they can be easily torn from the roll 1900. One surface 1904 includes an adhesive in one example.

FIG. 20 is a stack 2000 of multiple markers 572, according to an example. Each marker 572 can be peeled off from a remainder of the stack 2000 when the user is ready to place the marker on the wall. One surface 2004 includes an adhesive to be used to attach the marker 572 to the wall, in one example.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A system for providing a simulated image of a wall area to be painted, wherein the wall area to be painted has a perimeter and a plurality of corner locations, wherein the wall area to be painted includes three or more markers having a predetermined shape and size or a predetermined pattern, each marker positioned at a different corner location of the wall area to be painted, the system comprising:
(a) a reference image receiving module configured to receive a digital reference image of the wall area to be painted including the markers;
(b) a processor comprising a perimeter identification module configured to identify corner locations by identifying the predetermined shape and size or the predetermined pattern of each marker on the reference image, identify line locations extending between the markers and combine the line locations extending between the markers to form a perimeter path;
(c) a user input module configured to receive a color selection from a user input device;
(d) a simulation module configured to provide a modified reference image of the wall area to be painted simulating the color selection on the wall area to be painted within the perimeter path; and
(e) a color option module configured to do at least one of the following: (1) present a user with a color collection comprising an image of swatches of a plurality of colors, (2) receive a color identification from a user, and (3) enable the user to select a color from a photograph; wherein the color option module matches a color selected by the user to the closest matching color from a library of predetermined color options.

2. The system of claim 1 further comprising the markers, wherein the markers each define a surface comprising a temporary attachment mechanism.

3. The system of claim 2 wherein each marker has the predetermined shape and size, the system further comprising a pad comprising a stack of the three or more markers, wherein each marker is configured to be peeled off of the pad and then be attached to the perimeter of the wall area to be painted using the temporary attachment mechanism.

4. The system of claim 2 wherein each marker has the predetermined shape and size, the system further comprising a roll comprising a series of the three or more markers, wherein each marker is configured to be peeled off of the roll or torn off the roll, separated from the other markers and then be attached to the perimeter of the wall area to be painted using the temporary attachment mechanism.

5. The system of claim 2 wherein each marker has the predetermined pattern, wherein the pattern is a repeating pattern.

6. (canceled)

7. (canceled)

8. The system of claim 1 further comprising a simulation adjustment module configured to change the color selection on the modified reference image to be an adjusted color selection, wherein the simulation adjustment module is configured to receive the adjusted color selection while displaying the modified reference image.

9. The system of claim 1 further comprising a pattern simulation module for receiving a pattern selection from the user and providing the modified reference image with a color pattern corresponding to the pattern selection within the perimeter path.

10. The system of claim 9, wherein user selects two or more colors for the selected pattern.

11. The system of claim 9, wherein the pattern simulation module receives a resizing selection from the user.

12. The system of claim 1 wherein the reference image receiving module is configured to receive a lighting condition of the reference image.

13. The system of claim 1 further comprising a light adjustment module for receiving a lighting condition selection from the user and providing the modified reference image simulating the color selection in the selected lighting condition within the perimeter path.

14. The system of claim 1 further comprising an area calculation module configured to calculate an estimated surface area of the wall area to be painted using a known dimension of the predetermined shape or predetermined pattern and configured to provide the estimated surface area to the user.

15. The system of claim 14 further comprising a paint volume estimation module configured to calculate an estimated volume of paint required to paint the area to be painted using the estimated surface area.

16. The system of claim 14 further comprising a project estimation module configured to calculate a project time estimation based at least on the estimated surface area.

17. The system of claim 1 wherein the perimeter identification module is configured to automatically add an additional marker and close the perimeter path if 3 or less markers are identified.

18. A method for providing a simulated image of a wall area to be painted, wherein the wall area to be painted has a perimeter and a plurality of corner locations, wherein the wall area to be painted includes three or more markers having a predetermined shape and size or a predetermined pattern, each marker positioned at a different corner location of the wall area to be painted, the method comprising:
(a) receiving a digital reference image of the wall area to be painted including the markers;
(b) identifying a perimeter path of the wall area to be painted on the reference image by a processor, comprising the steps of identifying a corner location of each marker by identifying the predetermined shape and size or the predetermined pattern of each marker on the reference image, identifying line locations extending between the markers and combining the line locations extending between the markers to form a perimeter path;
(c) receiving a color selection from a user from a user input device; and
(f) providing a modified reference image of the wall area to be painted simulating the color selection on the wall area to be painted within the perimeter path; and
(g) providing a color option module configured to do at least one of the following: (1) present a user with a color collection comprising an image of swatches of a plurality of colors, (2) receive a color identification from a user, and (3) enable the user to select a color from a photograph; wherein the color option module matches a color selected by the user to the closest matching color from a library of predetermined color options.
